(19) United States
(12) Patent Application Publication
(10) Pub. No.: US 2023/0396110 A1
(43) Pub. Date: Dec. 7, 2023

(54) COIL, MOTOR, AND METHOD FOR MANUFACTURING COIL

(71) Applicant: Panasonic Intellectual Property Management Co., Ltd., Osaka (JP)

(72) Inventor: Mitsuoki HISHIDA, Osaka (JP)

(21) Appl. No.: 18/453,374

(22) Filed: Aug. 22, 2023

Related U.S. Application Data
(63) Continuation of application No. PCT/JP2022/018659, filed on Apr. 25, 2022.

(30) Foreign Application Priority Data
May 14, 2021 (JP) 2021-082162

(51) Int. Cl. H02K 3/18; H02K 21/16; H02K 15/04; B23K 26/38

(52) U.S. Cl. CPC H02K 3/18; B23K 26/38; H02K 15/0407; H02K 21/16

(57) ABSTRACT

Coil body (21) is formed by cutting a peripheral wall of cylindrical body (22) into a spiral shape. Coil body (21) is winding in six turns of first turn (A1) to sixth turn (A6). A cut face between turns of coil body (21) is inclined with respect to a plane orthogonal to the axial direction of coil body (21).

### TECHNICAL FIELD

The present disclosure relates to a coil, a motor, and a method for manufacturing a coil.

### BACKGROUND ART

Patent Literature 1 discloses a motor in which a coil winding around a tooth has a different cross-sectional area at a different turn, which enhances an effect of heat dissipation by the coil.

The coil is manufactured, for example, by cutting a peripheral wall of a cylindrical body having conductivity into a spiral shape by a laser beam emitted on and along a side wall of the cylindrical body.

### CITATION LIST

### Patent Literature

PTL 1: WO 2018/155221 A

### SUMMARY OF THE INVENTION

### Technical Problem

In a conventional invention, a cut face of a coil between turns is orthogonal to the axial direction of the coil. That is, when manufacturing a coil, a laser beam is emitted to a peripheral wall of a cylindrical body in a direction orthogonal to the axial direction.

Thus, a spatter or dross produced at the peripheral wall of the cylindrical body during laser processing may fly in the inside of the cylindrical body and adhere to a peripheral wall on the opposite side.

The present disclosure has been made in view of this issue. An object of the present disclosure is to suppress adhesion of a spatter, produced during laser processing, to the inside of a coil.

### Solution to Problem

A first invention is a coil including a coil body winding in a spiral shape, where the coil body is formed by cutting a peripheral wall of a cylindrical body having conductivity into a spiral shape that has n (an integer of 2 or more) winding turns of first to n-th turns, and, in a cross-section normal to an axial direction of the coil body, a cut face between turns has inclination of a predetermined angle with respect to a plane orthogonal to the axial direction of the coil body.

In the first invention, the coil body is formed by spirally cutting the peripheral wall of the cylindrical body. The coil body is winding n turns of first to n-th turns. A cut face between turns of the coil body is inclined with respect to a plane orthogonal to the axial direction of the coil body.

With this inclination, a spatter flies along the direction of inclination of the cut face when laser processing is performed on the peripheral wall of the cylindrical body, so that the spatter is readily released through the opening in the axial direction of the cylindrical body. Thus, adhesion of a spatter, produced during laser processing, to the inside of the coil body can be suppressed.

A second invention is the coil according to the first invention, where the coil body has a first opening opened at one end in the axial direction, and the cut face is inclined at an angle that allows a first extension line extending along the cut face to pass through the first opening.

In the second invention, the cut face has an inclination angle that allows the first extension line to pass through the first opening. When cutting the peripheral wall of the cylindrical body with a laser beam, the laser beam is emitted along the first extension line. Thus, a spatter produced during the laser processing flies through the first opening to the outside of the coil body, and adhesion of a spatter to the coil body can be suppressed.

A third invention is a coil according to the first or second invention in which the cut face has a different inclination angle at a different turn.

In the third invention, for example, the coil may have a small inclination angle at a cut face close to the opening of the coil body and a large inclination angle at a cut face far from the opening of the coil body. With this configuration, an angle of any cut face can be set to an angle that allows the first extension line to pass through the first opening.

A fourth invention is the coil according to any one of the first to third inventions, where the coil body has, besides the first opening at the one end in the axial direction, a second opening at another end in the axial direction, the cut face includes a first cut face and a second cut face, the first cut face is inclined at an angle that allows a first extension line extending along the first cut face to pass through the first opening, and the second cut face is inclined at an angle that allows a second extension line extending along the second cut face to pass through the second opening.

In the fourth invention, the first cut face close to the first opening is inclined at an angle that allows the first extension line to pass through the first opening. The second cut face close to the second opening is inclined at an angle that allows the second extension line to pass through the second opening. This configuration can suppress inclination angles of cut faces becoming large.

A fifth invention is the coil according to any one of the first to fourth inventions, where, in a cross-section of the coil body normal to the axial direction, the peripheral wall of the cylindrical body has substantially the same thickness over an entire circumference.

In the fifth invention, the peripheral wall of the cylindrical body has a substantially constant thickness over the entire circumference, so that when a laser beam is emitted on and along the peripheral wall of the cylindrical body, laser processing can be performed with the output of the laser beam kept substantially constant.

A sixth invention is a motor including the coil according to any one of the first to fifth inventions, and a stator including a tooth around which the coil winds.

The sixth invention can provide a motor including the coil described above.

A seventh invention is a method for manufacturing a coil including a coil body winding in a spiral shape, the method including a step of preparing a cylindrical body having conductivity, and a cutting step of cutting a peripheral wall of the cylindrical body into a spiral shape by a laser beam emitted on and along the peripheral wall of the cylindrical body to form the coil body, where, in the cutting step, the laser beam is emitted at an emission angle that allows the laser beam to pass through a first opening opened at one end in an axial direction of the cylindrical body.

In the seventh invention, a spatter flies along the direction of inclination of the cut face when laser processing is performed on the peripheral wall of the cylindrical body, so that the spatter is readily released through the opening in the axial direction of the cylindrical body. Thus, adhesion of a spatter, produced during laser processing, to the inside of the coil body can be suppressed.

An eighth invention is the method for manufacturing a coil according to the seventh invention, further including a step of moving a portion of the coil body in the axial direction to create a gap in a portion of the peripheral wall on a side opposite to a portion of the peripheral wall on which laser processing is performed, and a step of emitting the laser beam at an emission angle that allows the laser beam to pass through the gap.

In the eighth invention, when laser processing is performed on the peripheral wall of the cylindrical body, a spatter is readily released through the gap formed in the peripheral wall opposite to the peripheral wall on which the laser processing is performed. By giving a substantially constant inclination angle to the cut face at every turn, the cross-sectional area in a view looking the spiral direction can be made substantially the same. With this configuration, current resistance can be kept substantially uniform along the spiral direction.

### Advantageous Effect of Invention

According to the present disclosure, adhesion of a spatter, produced during laser processing, to the inside of the coil body can be suppressed.

### BRIEF DESCRIPTION OF THE DRAWINGS

FIG. 1 is a plan view illustrating a configuration of a motor according to a first exemplary embodiment.

FIG. 2 is a side view illustrating a configuration of the motor.

FIG. 3 is a plan cross-sectional view illustrating a configuration of the motor.

FIG. 4 is a plan cross-sectional view illustrating a configuration of a coil.

FIG. 5 is a perspective view illustrating a configuration of a coil body on which laser processing is being performed.

FIG. 6 is a cross-sectional view illustrating a configuration of the coil body in which laser processing is performed for a sixth turn.

FIG. 7 is a cross-sectional view illustrating a configuration of the coil body in which laser processing is performed for a fourth turn.

FIG. 8 is a cross-sectional view for explaining a laser output during laser processing in a comparative example.

FIG. 9 is a cross-sectional view for explaining laser output during laser processing in the present exemplary embodiment.

FIG. 10 is a plan cross-sectional view illustrating a configuration of a coil according to a second exemplary embodiment.

FIG. 11 is a cross-sectional view for explaining a direction of inclination of a cut face.

### DESCRIPTION OF EMBODIMENT

Exemplary embodiments of the present disclosure will now be described with reference to the drawings. The following descriptions of preferable exemplary embodiments are merely illustrative in nature, and are not intended to limit the scope, applications, or use of the present disclosure in any way.

### First Exemplary Embodiment

### Motor Structure

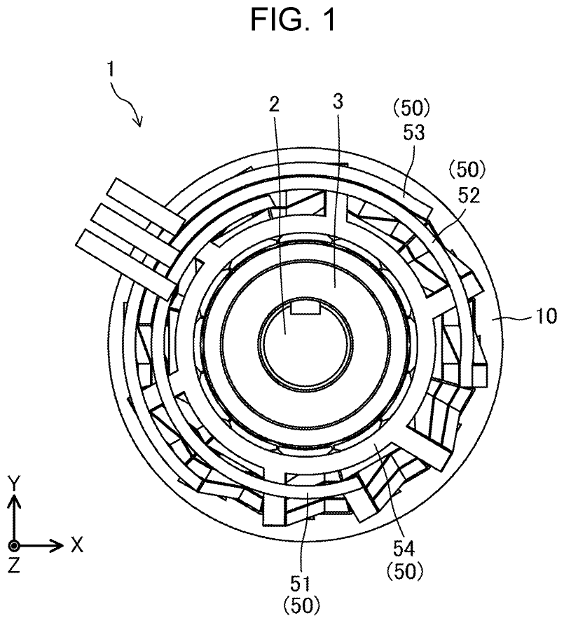

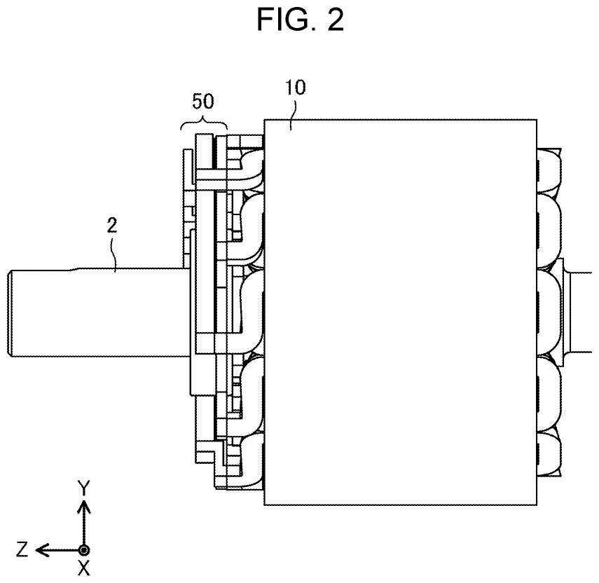

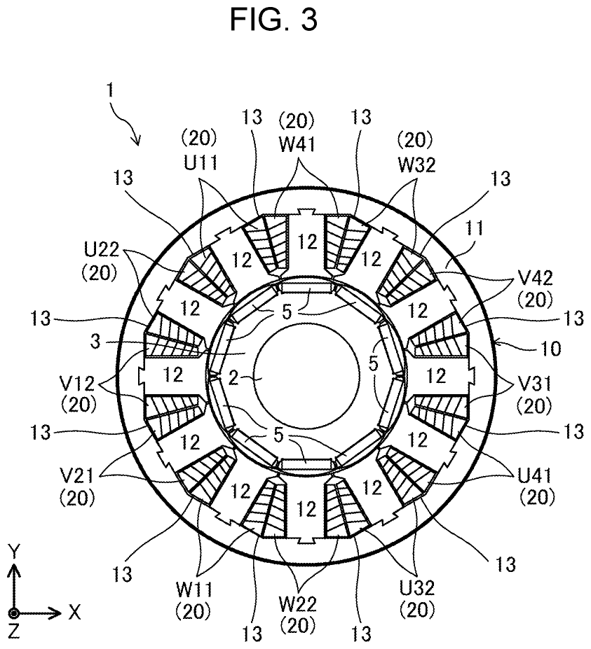

As illustrated in FIGS. 1 to 3, motor 1 includes shaft 2, rotor 3, stator 10, coil 20, and bus bar 50.

In the present exemplary embodiment, the longitudinal direction of shaft 2 (the direction normal to the sheet on which FIG. 1 is drawn) may be referred to as Z-axis direction. A direction orthogonal to Z-axis direction (a direction parallel to the sheet on which FIG. 1 is drawn) may be referred to as X-axis direction or Y-axis direction.

Term “integrated” or “integrally” denotes a state of a single object in which a plurality of parts are not only mechanically coupled with bolts or by swaging, for example, but also electrically coupled through a material bond such as a covalent bond, an ion bond, or a metallic bond, or a state of a single object in which a plurality of parts are electrically coupled through a material bond made by melting of the entire parts.

Rotor 3 is provided to be in contact with the outer circumference of shaft 2. Rotor 3 includes a plurality of magnets 5. The plurality of magnets 5 are arranged to face stator with N poles and S poles alternately disposed along the outer circumferential direction of shaft 2.

In the present exemplary embodiment, neodymium magnets are used as magnets 5 used in rotor 3, and material, shape, and material properties of magnets 5 may be appropriately changed depending on an output, for example, of a motor.

Stator 10 includes stator core 11, a plurality of teeth 12, and a plurality of slots 13. Stator core 11 has a substantially annular shape. Stator core 11 is formed by, for example, die-cutting laminated magnetic steel sheets containing silicon or the like.

The plurality of teeth 12 are provided at a constant interval along the inner circumference of stator core 11. Teeth 12 protrude radially inward from stator core 11. Each of the plurality of slots 13 is provided between the corresponding two of the plurality of teeth 12.

Stator 10 is disposed on the outer side of rotor 3, and separated from rotor 3 by a certain distance in a view in Z-axis direction.

In the present exemplary embodiment, rotor 3 includes total 10 magnetic poles, that is, five N-poles and five S-poles facing stator 10, and 12 slots 13, but the numbers of magnetic poles and slots are not particularly limited. A combination of magnetic poles and slots of different numbers is also applicable.

Stator 10 has 12 coils 20. Each coil 20 is attached to the corresponding one of teeth 12. Each coil 20 is disposed in the corresponding one of slots 13 in a view along Z-axis direction. That is, coil 20 winds around tooth 12 in concentrated winding.

Bus bar 50 includes first bus bar 51, second bus bar 52, third bus bar 53, and fourth bus bar 54. Among the plurality of coils 20, coils 20 denoted by reference marks U11 to W41 are integrated with first bus bar 51. Coils 20 denoted by reference marks V12 to V42 are integrated with second bus bar 52. Coils 20 denoted by reference marks W11 to W41 are integrated with third bus bar 53.

Marks Uxy, Vxy, and Wxy representing coils 20 each have a first character representing a phase (U-phase, V-phase, or W-phase in the present exemplary embodiment) of motor 1. A second character represents a number of sequential order among coils 20 of the same phase. A third character represents a winding direction of coil 20. In the present exemplary embodiment, 1 represents a clockwise direction, and 2 represents a counterclockwise direction.

For example, coil U11 is the first coil in the sequential order of U-phase and the winding direction of coil U11 is clockwise. Coil V42 is the fourth coil in the sequential order of V-phase and the winding direction of coil V42 is counterclockwise.

Note that, “clockwise” means clockwise in a view looking from the center of motor 1, and “counterclockwise” means counterclockwise in a view looking from the center of motor 1.

Technically, coils U11, U41 are U-phase coils, and coils U22, U32 are U bar phase coils (generating a magnetic field in a direction opposite to that of the magnetic field generated by a U-phase coil). In the following description, these coils are collectively referred to as U-phase coils unless otherwise specified. Similarly, coils V12 to V42 are collectively referred to as V-phase coils, and coils W11 to W41 are collectively referred to as W-phase coils.

### Features of Coil Cross Section

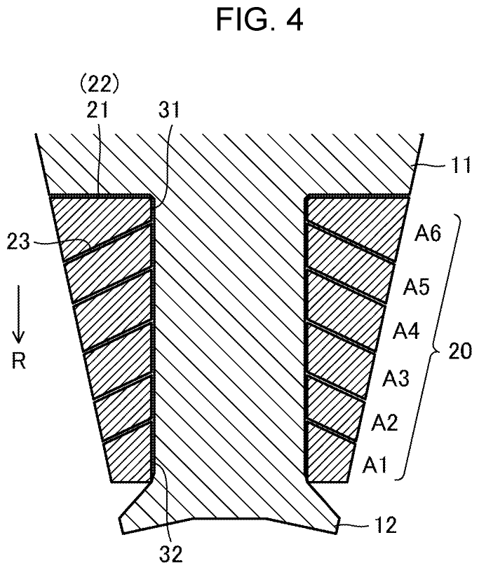

As illustrated in FIG. 4, coil 20 has coil body 21 that is spirally winding. Coil body 21 is formed of, for example, copper, aluminum, zinc, magnesium, brass, iron, or stainless steel (SUS). An insulating coating (not illustrated) is provided on the surface of coil body 21.

In FIG. 4, a direction in which tooth 12 protrudes from stator core 11 is defined as R direction. Coil 20 winds around tooth 12 six turns. Reference marks A1 to A6 denote cross sections of coil 20 at the first turn to the sixth turn. First turn A1 of coil 20 is located close to the center of motor 1 in R direction.

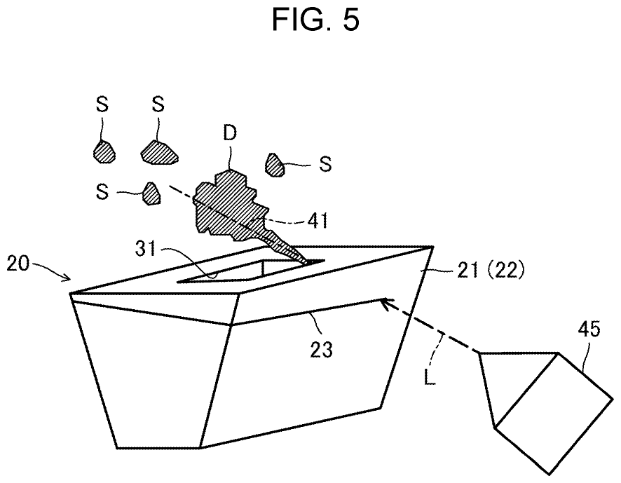

Coil body 21 is formed by cutting the peripheral wall of cylindrical body 22 into a spiral shape (see FIG. 5). First opening 31 is opened at one end (upper side in FIG. 4) in the axial direction of coil body 21. Second opening 32 is opened at another end (lower side in FIG. 4) in the axial direction of coil body 21.

In a cross-section parallel to the axial direction (R direction in FIG. 4) of coil body 21, cut face 23 between turns has inclination of a predetermined angle with respect to a plane orthogonal to the axial direction (R direction in FIG. 4) of coil body 21.

Specifically, as illustrated in FIG. 5, coil body 21 is cut by laser beam L emitted from laser head 45 to the peripheral wall of cylindrical body 22. Cut face 23 created by cutting by laser beam L is inclined at an angle that allows first extension line 41 extending along cut face 23 to pass through first opening 31.

Thus, spatter S and dross D flies along the direction of inclination of cut face 23 when laser processing is performed on the peripheral wall of cylindrical body 22, and spatter S is readily released through first opening 31 of cylindrical body 22. Thus, adhesion of spatter S or the like, produced during laser processing, to the inside of coil body 21 can be suppressed.

[Manufacturing method for coil] A method for manufacturing coil 20 will be described. First, as illustrated in FIG. 5, cylindrical body 22 having conductivity is prepared. Cylindrical body 22 is formed of, for example, a copper tube. A hole penetrating a copper block in the up-down direction in FIG. 5 may be formed by laser beam L emitted from above. Alternatively, a hole may be formed by machining.

Next, laser beam L is emitted from laser head 45 to the peripheral wall of cylindrical body 22. In this process, laser head 45 is moved along the peripheral wall of cylindrical body 22 in a spiral manner to cut the peripheral wall of cylindrical body 22 into a spiral shape. Laser head 45 is inclined at a predetermined angle with respect to a plane orthogonal to the axial direction of cylindrical body 22.

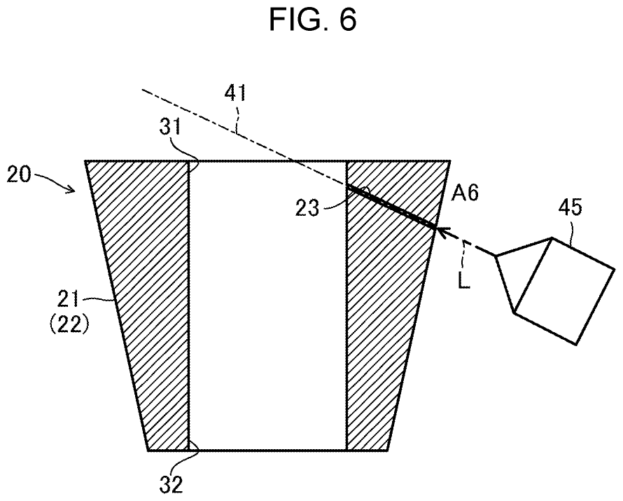

As illustrated in FIG. 6, when forming sixth turn A6 in coil 20, cut face 23 between sixth turn A6 and fifth turn A5 is made to have an angle that allows first extension line 41 extending along cut face 23 to pass through first opening 31.

Therefore, spatter S and dross D produced during laser processing (see FIG. 5) fly along the direction of inclination of cut face 23, and can be released from first opening 31 to the outside of coil 20.

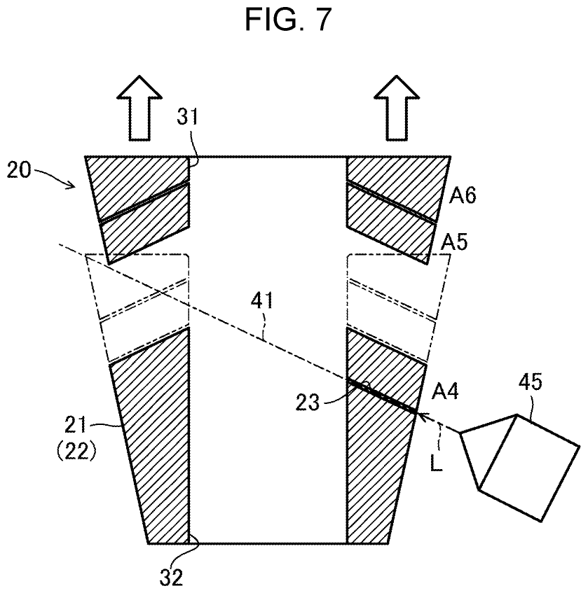

As illustrated in FIG. 7, cut face 23 between fifth turn A5 and fourth turn A4 is created by cutting with the same inclination angle as cut face 23 between sixth turn A6 and fifth turn A5. Similarly, cut face 23 between fifth turn A5 and fourth turn A4 has an angle that allows first extension line 41 to pass through first opening 31. Furthermore, it is desirable that cross-sectional areas in a view looking the spiral direction are substantially the same. With this configuration, current resistance is kept substantially uniform along the spiral direction.

Similarly, cut face 23 between fourth turn A4 and third turn A3 is created by cutting with the same inclination angle as other cut faces 23. When laser processing is performed to create cut face 23 between fourth turn A4 and third turn A3, the peripheral wall opposite to the peripheral wall on which the laser processing is performed overlaps first extension line 41.

To form fourth turn A4 of coil 20, sixth turn A6 and fifth turn A5 are lifted upward, in FIG. 7, to create a gap through which first extension line 41 passes, and then laser processing is performed.

In this manner, spatter S or the like produced during laser processing flies out through the gap, and adhesion of spatter S can be suppressed. Similarly, to form third turn A3, second turn A2, and first turn A1, a gap through which first extension line 41 passes through is created, and then laser processing is performed.

Coil 20 including spirally winding coil body 21 can be manufactured by cutting by laser beam L emitted in a spiral manner.

In a cross-section normal to the axial direction of coil body 21, when the thickness of the peripheral wall of cylindrical body 22 differs at different places, a laser output needs to be changed, corresponding to the thickness of the peripheral wall, during laser processing, and this makes it difficult to secure processing quality.

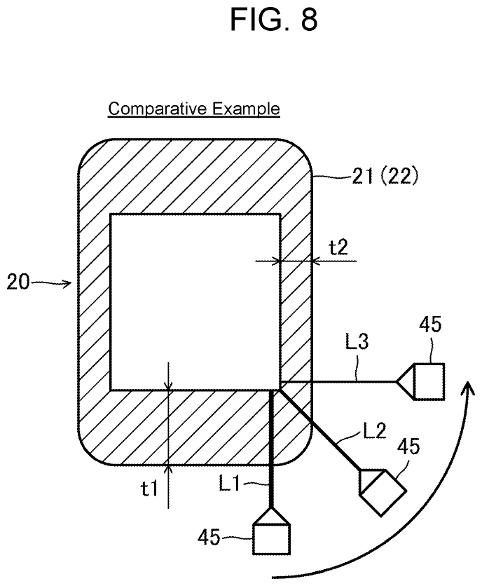

Specifically, as illustrated in a comparative example in FIG. 8, t1>t2 is satisfied where t1 is the thickness of the peripheral wall in the up-down direction and t2 is the thickness of the peripheral wall in the left-right direction. When laser processing is performed on the lower right corner in FIG. 8, L1>L2>L3 is satisfied where L1 is a laser output for thickness t1, L2 is a laser output for the corner, and L3 is a laser output for thickness t2.

Therefore, when laser head 45 provides a laser output while moving along the corner, it is necessary to adjust the laser output according to the position from which laser beam L is emitted, and this makes the control difficult.

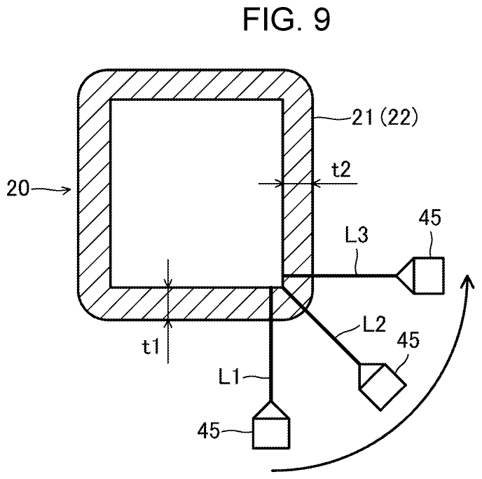

In contrast, in the present exemplary embodiment, as illustrated in FIG. 9, in a cross-section normal to the axial direction of coil body 21, the peripheral wall of cylindrical body 22 has substantially the same thickness over the entire circumference.

Specifically, t1=t2 is satisfied where the peripheral wall of cylindrical body 22 has thickness t1 in the up-down direction in FIG. 9 and thickness t2 in the left-right direction in FIG. 9. For example, when laser processing is performed on the lower right corner in FIG. 9, L1=L2=L3 is satisfied where L1 is a laser output for thickness t1, L2 is a laser output for the corner, and L3 is a laser output for thickness t2.

As described above, since the peripheral wall of cylindrical body 22 has a substantially constant thickness over the entire circumference, laser processing can be performed with the output of laser beam L emitted on and along the peripheral wall of cylindrical body 22 kept substantially constant.

### Second Exemplary Embodiment

A part same as the part in the first exemplary embodiment will be denoted by the same reference mark, and only the difference will be described.

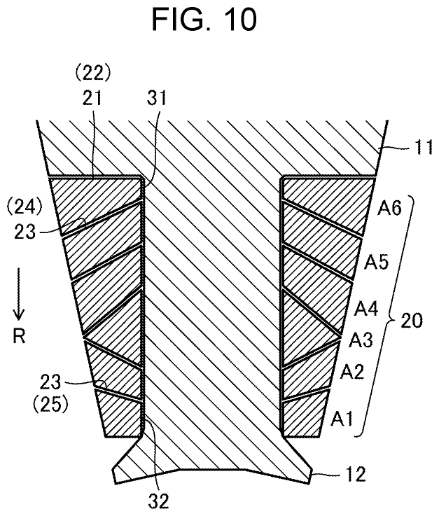

As illustrated in FIG. 10, coil 20 has coil body 21 that is spirally winding. Coil 20 winds around tooth 12 six turns. Coil body 21 is formed by cutting the peripheral wall of cylindrical body 22 into a spiral shape. First opening 31 is opened at one end (upper side in FIG. 10) in the axial direction of coil body 21. Second opening 32 is opened at another end (lower side in FIG. 10) in the axial direction of coil body 21.

In a cross-section parallel to the axial direction (R direction in FIG. 10) of coil body 21, cut face 23 between turns has inclination of a predetermined angle with respect to a plane orthogonal to the axial direction (R direction in FIG. 10) of coil body 21. Cut face 23 has a different inclination angle at a different turn.

Specifically, cut face 23 includes first cut face 24 and second cut face 25. First cut face 24 is inclined at an angle that allows first extension line 41 extending along first cut face 24 to pass through first opening 31. Second cut face 25 is inclined at an angle that allows second extension line 42 extending along second cut face 25 to pass through second opening 32.

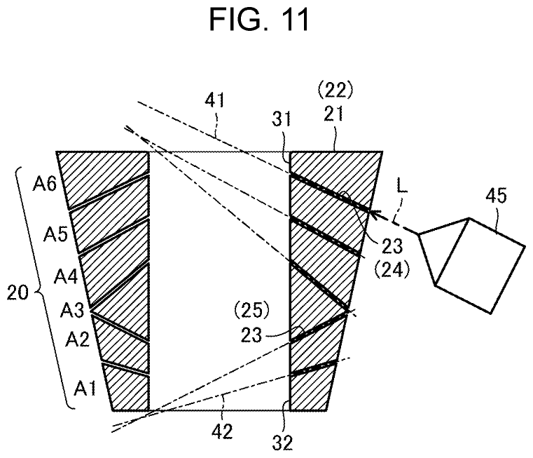

In an example illustrated in FIG. 11, first cut face 24 is formed between sixth turn A6 and fifth turn A5, between fifth turn A5 and fourth turn A4, and between fourth turn A4 and third turn A3.

First cut face 24 between fifth turn A5 and fourth turn A4 has an inclination angle larger than the inclination angle of first cut face 24 between sixth turn A6 and fifth turn A5. First cut face 24 between fourth turn A4 and third turn A3 has an inclination angle larger than the inclination angle of cut face 23 between fifth turn A5 and fourth turn A4.

As described above, by giving a small inclination angle to first cut face 24 close to first opening 31 of coil body 21 and giving a large inclination angle to first cut face 24 far from first opening 31 of coil body 21, an inclination angle that allows first extension line 41 to pass through first opening 31 can be given to every first cut face 24.

Second cut face 25 is formed between third turn A3 and second turn A2 and between second turn A2 and first turn A1.

Second cut face 25 between third turn A3 and second turn A2 has an inclination angle larger than the inclination angle of second cut face 25 between second turn A2 and first turn A1.

As described above, by giving a small inclination angle to second cut face 25 close to second opening 32 of coil body 21 and giving a large inclination angle to second cut face 25 far from second opening 32 of coil body 21, an inclination angle that allows second extension line 42 to pass through second opening 32 can be given to any second cut face 25.

### Other Exemplary Embodiments

The above exemplary embodiment may take the following configuration.

In the present exemplary embodiment, the number of turns of coil 20 is six, but the number of turns is not particularly limited to six. The number of turns may be appropriately changed in accordance with the size or performance, for example, of motor 1.

### INDUSTRIAL APPLICABILITY

As described above, the present disclosure is very useful and has high industrial applicability since a highly practical effect of suppressing adhesion of a spatter, produced during laser processing, to the inside of a coil can be obtained.

### REFERENCE MARKS IN THE DRAWINGS

1 motor
10 stator
11 stator core
12 tooth
20 coil
21 coil body
23 cut face
24 first cut face
25 second cut face
31 first opening
32 second opening
41 first extension line
42 second extension line
A1 first turn
A2 second turn
A3 third turn
A4 fourth turn
A5 fifth turn
A6 sixth turn
L laser beam

1. A coil comprising a coil body winding in a spiral shape, wherein
the coil body is formed by cutting a peripheral wall of a cylindrical body having conductivity into a spiral shape that has n winding turns of first to n-th turns, where n is an integer of 2 or more, and
in a cross-section normal to an axial direction of the coil body, a cut face between the turns has inclination of a predetermined angle with respect to a plane orthogonal to the axial direction of the coil body.

2. The coil according to claim 1, wherein
the coil body has a first opening opened at one end in the axial direction, and
the cut face is inclined at an angle that allows a first extension line extending along the cut face to pass through the first opening.

3. The coil according to claim 1, wherein the cut face has a different inclination angle at a different turn.

4. The coil according to claim 1, wherein
the coil body has, besides the first opening at the one end in the axial direction, a second opening at another end in the axial direction,
the cut face includes a first cut face and a second cut face,
the first cut face is inclined at an angle that allows a first extension line extending along the first cut face to pass through the first opening, and
the second cut face is inclined at an angle that allows a second extension line extending along the second cut face to pass through the second opening.

5. The coil according to claim 1, wherein in a cross-section of the coil body normal to the axial direction, the peripheral wall of the cylindrical body has substantially a same thickness over an entire circumference.

6. A motor comprising:
the coil according to claim 1; and
a stator including a tooth around which the coil is winding.

7. A method for manufacturing a coil including a coil body winding in a spiral shape, the method comprising:
preparing a cylindrical body having conductivity; and
cutting a peripheral wall of the cylindrical body into a spiral shape by a laser beam emitted on and along the peripheral wall of the cylindrical body to form the coil body, wherein
the cutting, the laser beam is emitted at an emission angle that allows the laser beam to pass through a first opening opened at one end in an axial direction of the cylindrical body.

8. The method for manufacturing a coil according to claim 7, further comprising:
moving a portion of the coil body in the axial direction to create a gap in a portion of the peripheral wall on a side opposite to a portion of the peripheral wall on which laser processing is performed; and
emitting the laser beam at an emission angle that allows the laser beam to pass through the gap.
